(19) United States
(12) Patent Application Publication
(10) Pub. No.: US 2021/0329771 A1
(43) Pub. Date: Oct. 21, 2021

(54) PLASMA TORCH

(71) Applicant: KJELLBERG-STIFTUNG, Finsterwalde (DE)

(72) Inventors: Volker KRINK, Finsterwalde (DE); Timo GRUNDKE, Finsterwalde (DE); Frank LAURISCH, Finsterwalde (DE); Rene NOGOWSKI, Dresden (DE)

(73) Assignee: KJELLBERG-STIFTUNG, Finsterwalde (DE)

(21) Appl. No.: 16/322,720

(22) PCT Filed: Jul. 27, 2017
(86) PCT No.: PCT/EP2017/069020

§ 371 Date: Feb. 1, 2019

(30) Foreign Application Priority Data
Aug. 1, 2016 (DE) 102016214146.5

(51) Int. Cl. H05H 1/34; H05H 1/28

(52) U.S. Cl. CPC H05H 1/341; H05H 1/3457; H05H 1/28

(57) ABSTRACT

The invention relates to a plasma torch, in particular plasma cutting torch, in which at least one secondary medium is guided by at least one feeder through a housing of the plasma torch to a nozzle protection cap opening and/or to further openings that are provided in a nozzle protection cap. In the at least one feeder, at least one valve for opening and closing the feeder is provided directly within the housing of the plasma torch.

### BACKGROUND OF THE INVENTION

The invention relates to a plasma torch, in particular a plasma cutting torch.

Plasma is a thermally highly heated electrically conductive gas, which consists of positive and negative ions, electrons and excited and neutral atoms and molecules. As plasma gas, use is made of a variety of gases, for example the monatomic argon and/or the diatomic gases hydrogen, nitrogen, oxygen or air. These gases ionize and dissociate owing to the energy of an arc. The arc constricted through a nozzle is then referred to as plasma jet. The plasma jet can be greatly influenced in its parameters by means of the design of the nozzle and electrode. These parameters of the plasma jet are, for example, the jet diameter, the temperature, the energy density and the flow velocity of the gas.

In plasma cutting, the plasma is usually constricted by means of a nozzle, which may be gas-cooled or water-cooled. As a result, energy densities of up to 2×10⁶ W/cm² can be achieved. Temperatures of up to 30 000° C. are generated in the plasma jet, which, in combination with the high flow velocity of the gas, produce very high cutting speeds on materials.

Plasma torches usually consist of a plasma torch head and a plasma torch shank. An electrode and a nozzle are fastened in the plasma torch head. Between them flows the plasma gas, which exits through the nozzle bore. The plasma gas is normally guided through a gas guide fitted between the electrode and the nozzle, and can be caused to rotate.

Modern plasma torches also have a feeder for a secondary medium, either a gas or a liquid. The nozzle is then surrounded by a nozzle protection cap. The nozzle is fixed, in particular in the case of liquid-cooled plasma torches, by a nozzle cap as described, for example, in DE 10 2004 049 445 A1. The cooling medium then flows between the nozzle cap and the nozzle. The secondary medium then flows between the nozzle or the nozzle cap and the nozzle protection cap and exits the bore of the nozzle protection cap. Said secondary medium influences the plasma jet formed by the arc and the plasma gas. Said secondary medium may be set in rotation by a gas guide which is arranged between nozzle or nozzle cap and nozzle protection cap.

The nozzle protection cap protects the nozzle and the nozzle cap from the heat or spraying-out molten metal of the workpiece, in particular during the plunge cutting by the plasma jet into the material of the workpiece to be cut. In addition, said nozzle protection cap creates a defined atmosphere around the plasma jet during the cutting.

For example, nitrogen is often used as secondary gas in order, during the plasma cutting of alloy steels, to prevent oxygen that is present on the ambi-ent air from coming into contact with, and oxidizing, the hot cut edges. Furthermore, the nitrogen has the effect that the surface tension of the melt is reduced, and is thus driven out of the kerf more effectively. Burr-free cuts are formed.

Also with the use of oxygen as plasma gas for the cutting of structural steels, different effects with regard to the cut quality can be achieved by means of different compositions of the secondary gas, as described in DE 10 2006 018 858 A1, for example different nitrogen and oxygen fractions.

It is likewise known to change the composition of the secondary gas between the individual cutting operations in order to firstly cut small holes and then cut large contours. Here, the switching takes place in the time period in which no cutting is performed.

Arrangements are also known in which valves, preferably electromagnetically operated valves, switch or regulate the secondary medium. These are located at a coupling unit between the gas hoses of the plasma torch and the supply hoses for the gas supply.

Disadvantages of the prior art are:
It is not possible to quickly activate and deactivate the secondary me-dium
It is not possible to quickly switch from one to another secondary me-dium
It is not possible during the cutting process to quickly react to changes, for example during the start of cutting, plunge cutting, piercing, during the cutting process, as the kerf is passed over or at the end of cutting, by switching of the secondary medium.
It is not possible to quickly change between two cutting processes.

Lines between valves and the plasma torch are the reason for this. This is particularly critical if it is necessary to switch between different secondary media, for example an oxidizing (oxygen, air) and a non-oxidizing gas or gas mixture. The switch between a liquid (for example water, emulsion, oil, aerosol) and a gas, is likewise critical because, when using a common feeder, for example a hose, the gas must firstly purge all of the liquid that remains therein. This can take several 100 ms.

The fitting of valves on the plasma torch shank is unfavorable for the fastening in the guide system, and is disruptive in particular in the case of pivoting assemblies.

### SUMMARY OF THE INVENTION

It is therefore an object of the invention to specify possibilities for improved conditions in the feed of secondary medium upon deactivation, switching or changes in controlled or regulated operation of a plasma torch.

In the case of the plasma torch according to the invention, in particular plasma cutting torch, at least one secondary medium is guided by at least one feeder through a housing of the plasma torch to a nozzle protection cap opening and/or to further openings that are provided in a nozzle protection cap. In the at least one feeder, at least one valve for opening and closing the feeder is provided directly within the housing of the plasma torch.

The feeder may advantageously be divided into at least two parallel feeders through which secondary medium flows in the direction of the nozzle protection cap opening and/or further openings, and at least two valves, which are each individually activatable, for opening and closing the respective divided feeder are then provided within the housing, such that it is possible for one of the valves on its own to open the feeder of the secondary medium, for secondary medium to flow through both divided feeders simultaneously, or for a switch to be performed from one to the other divided feeder.

It is possible for an aperture, a throttle, or an element which varies the free cross section of the respective feeder in relation to the free cross section in relation to the respective other divided feeder to be used in at least one of the split feeders, such that different flow resistances in the divided feeders for a secondary medium, and different flow speeds and pressures of the secondary medium, can be realized.

Particularly advantageously, at least two feeders for two different secondary media may be led through the housing of the plasma torch to a nozzle protection cap opening and/or led to further openings that are provided in the nozzle protection cap, and, in the feeders for in each case one secondary medium within the housing, there may be provided in each case at least one valve for opening and closing the respective feeder.

The feeders should be designed such that the merging of the divided feeders for one secondary medium or the merging of the feeders for different secondary media takes place within the housing of the plasma torch, within the plasma head, in a space formed with the nozzle or nozzle cap and the nozzle protection cap, the confluence of the secondary media streams from the divided feeders and/or before, during or after the passage through a gas guide of the plasma torch. Accordingly, the confluence should occur within the housing or plasma head.

At least two openings or two groups of openings that guide the respective secondary medium/media should be provided on the gas guide. With these openings, a targeted influence on the secondary media exiting the openings can be achieved. For this purpose, the openings may have free cross sections of different size and geometrical shape and/or may be oriented in different axial directions. Openings of different groups may be arranged radially offset with respect to one another. Also, the number of openings may be chosen differently in the individual groups.

The valves arranged within the housing may be operated electrically, pneumatically or hydraulically, and may particularly preferably be designed as axial valves.

The valves arranged in the housing should have a maximum outer diameter or a maximum average surface diagonal of 15 mm, preferably at most 11 mm, and/or a maximum length of 50 mm, preferably at most 40 mm, particularly preferably at most 30 mm, and/or the maximum outer diameter of the housing should be 52 mm and/or the maximum outer diameter of the valves should be at most ¼, preferably at most ⅕, of the outer diameter or of a maximum average surface diagonal of the housing, and/or should require a maximum electrical power consumption of 10 W, preferably of 3 W, particularly preferably of 2 W, for their operation.

In the case of one or more electrically operable valve(s), the respective secondary medium or the plasma gas should flow through the winding of a coil (S) in order to realize a cooling effect.

Advantageously, can be designed as a quick-exchange torch with a plasma torch shank which is separable from a plasma torch head. In this way, it is possible to quickly and easily achieve to different machining tasks.

In addition to the nozzle protection cap opening or a holder of the nozzle protection cap, the nozzle protection cap should have at least one opening through which at least a fraction of the secondary media flows. In the case of several openings being provided, in each case one secondary medium can exit through one or more selected opening(s) in the direction of a workpiece surface. It is however also possible, as already discussed, for a secondary medium to flow out through one group of openings, and for another secondary medium to be allowed to flow out through openings assigned to another group. It is also possible for at least one opening to be provided through which a secondary medium mixture formed from two different secondary media can exit.

Gaseous and/or liquid secondary media may be used. These may be two different gases, for example selected from oxygen, nitrogen and a noble gas, two different liquids, for example selected from water, an emulsion, oil and an aerosol, or a gaseous and a liquid secondary medium. However, it is also possible to use two secondary medium mixtures which are each formed with the same gases and/or liquids, and, here, only the fractions of the secondary media forming the respective mixture differ from one another. This may be, for example, a different fraction of oxygen contained in the secondary media mixture.

The valve(s) which is/are arranged in a feeders for secondary medium should be open when at least a part of the electrical cutting current flows through the workpiece, such that in this operating state, secondary medium can flow out of the plasma torch in the direction of a workpiece surface. In a time period in which a pilot arc is formed, the valve(s) should be held closed. This can be achieved by means of a controller, which is preferably connected to a database.

During the plunge cutting of the plasma jet into the material of the workpiece, a liquid or a liquid-gas mixture may be used as a secondary medium, and for the cutting, a gas or gas mixture may be used as a secondary medium.

The valve(s) which is/are arranged in a feeder for secondary medium should be opened, such that secondary medium then flows out of the nozzle protection cap bore, at the earliest at the point in time at which, during the plunge cutting into a workpiece, the workpiece has been pierced by at least ⅓, preferably by half and ideally completely.

At least one valve which is arranged in a feeder for secondary medium should be able to be activated, deactivated during the start of cutting, between two cutting portions, upon the crossing of a kerf F or at the end of cutting. There is the possibility here of switching two valves, which are arranged in two different feeders for secondary medium, upon or during these machining tasks. That is to say that a hitherto open valve can be closed and a hitherto closed valve can be opened.

Upon a start of cutting by means of a plasma jet, a plunge cut or starting cut can be performed.

During the cutting of a contour, a change of the parameters of the secondary medium (as described above) may be performed, and at least one further parameter of the plasma cutting process may be changed. This may be, for example, an adaptation of the electrical parameters, an adaptation of the advancing speed, of the volume flow, of the spacing of the plasma torch to the workpiece surface, and/or the composition of the plasma gas. For this purpose, all parameters may be stored in a database and used so that automatic operation by means of a controller of the plasma torch is possible. In addition to the parameters mentioned, the parameters for the respective machining of a workpiece may also be provided in the database and used.

### DESCRIPTION OF THE DRAWINGS

The invention will be explained by way of example below. The individual features shown in the figures and explained in regards thereto may be combined with one another independently of the respective example or the respective figure.

Here, in the figures:

FIG. 1 shows in schematic form a sectional illustration through an example of a plasma torch according to the invention with a secondary medium feeder with a valve and a plasma gas feeder;

FIG. 2 shows in schematic form a sectional illustration through an example of a plasma torch according to the invention with a secondary medium feeder with two valves and a plasma gas feeder;

FIG. 3 shows in schematic form a sectional illustration through a further example of a plasma torch according to the invention with a secondary medium feeder with two valves and a plasma gas feeder;

FIG. 4 shows in schematic form a sectional illustration through a further example of a plasma torch according to the invention with a secondary medium feeder with two valves and a plasma gas feeder;

FIG. 5 consists of FIGS. 5A and 5B shows a guide for secondary media;

FIG. 6 shows in schematic form a sectional illustration through an example of a plasma torch according to the invention with two secondary medium feeders with two valves and a plasma gas feeder;

FIG. 7 shows in schematic form a sectional illustration through a further example of a plasma torch according to the invention with two secondary media feeders with two valves and a plasma gas feeder;

FIG. 8 shows in schematic form a sectional illustration through a further example of a plasma torch according to the invention with two secondary medium feeders with two valves and a plasma gas feeder;

FIG. 9 shows in schematic form a sectional illustration through an example of a plasma torch according to the invention with two secondary medium feeders with two valves and a plasma gas feeder with a valve and a ventilation valve;

FIG. 10 shows in schematic form a sectional illustration through an example of a plasma torch according to the invention with two secondary medium feeders with two valves and two plasma gas feeders with two valves and a ventilation valve;

FIG. 11 shows a sectional illustration through an axial valve that can be used in the case of the invention;

FIG. 12 shows a possibility for the arrangement of valves within the housing of a plasma torch, and

FIG. 13 shows a further possibility for the arrangement of valves within the housing of a plasma torch.

FIG. 14 shows a further possibility for the arrangement of valves within the housing of a plasma torch.

FIG. 15 consists of FIGS. 15A and 15B each showing a cut contour with large and small portions (contours)

FIG. 16 consists of FIGS. 16A and 16B showing a cut contour with perpendicular and bevelled cuts, and

FIG. 17 shows a plasma torch with its positioning relative to the workpiece.

### DETAILED DESCRIPTION OF THE DRAWINGS

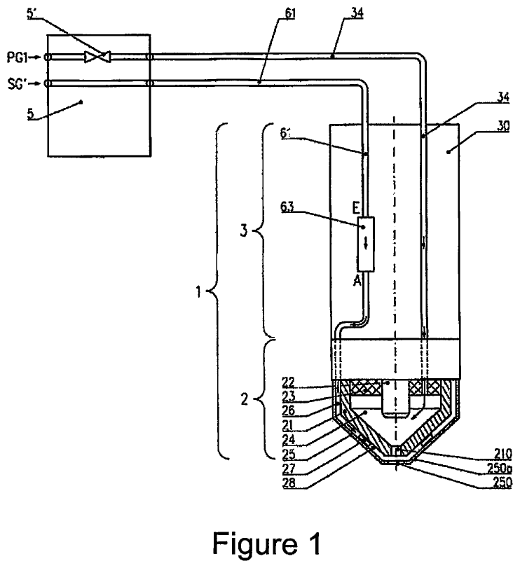

FIG. 1 shows a plasma torch 1 with a plasma torch head 2 with a nozzle 21, an electrode 22, a nozzle protection cap 25, a feeder 34 for a plasma gas PG1, a feeder 61 for the secondary medium SG1, and a plasma torch shank 3, which has a housing 30. In the case of the invention, that is to say also in all of the other examples that fall within the invention, the plasma torch shank 3 may be formed in one piece and formed only with a correspondingly configured housing 30 on which all of the necessary components may be provided and formed.

The feeder 61 may, outside the housing 30, be a gas hose which is connected, for a feed of secondary medium SG1, to a coupling unit 5. The gas hose is adjoined by a further part of the feeder 61 and by the valve 63, which are arranged within the housing 30.

The feeder 34 may, outside the housing 30, be a gas hose which is connected, for a feed of plasma gas PG1, to a coupling unit 5. In the coupling unit 5, there is arranged a solenoid valve 51 for opening and closing the feeder 34. The gas hose is adjoined by a further part of the feeder 34, which is formed within the housing 30.

The electrode 22 and the nozzle 21 are arranged so as to be spaced apart from one another by the gas guide 23, so that a space 24 is formed within the nozzle 21. The feeder 34 of the plasma gas PG1 is connected to the space 24. The nozzle 21 has a nozzle bore 210 which, depending on the electrical cutting current, may vary in diameter from 0.5 mm for 20 A to 7 mm for 800 A. The gas guide 23 likewise has openings or bores (not shown) through which the plasma gas PG1 flows. These may likewise be configured to be of different size or diameter and even number.

The nozzle 21 and the nozzle protection cap 25 are arranged so as to be spaced apart from one another so that the spaces 26 and 28 are formed within the nozzle protection cap 25. The space 26 is situated in front of the guide 27 as viewed in the flow direction of the secondary medium SG1, and the space 28 is situated between the guide 27 and the nozzle protection cap opening 250. With the aid of the gas guide 27, the flow of the secondary medium SG1, for example, a gas, gas mixture, a liquid or a gas-liquid mixture, can be balanced and/or set in rotation. It is also possible for no guide 27 to be used if, for example, no rotation of the secondary medium SG1 is desired. The nozzle 21 may furthermore be fixed by means of a nozzle cap or the like (not shown). Then, the nozzle cap and the nozzle protection cap form the spaces 26 and 28.

The secondary gas SG1 is thus conducted via the feeder 61 and the valve 63 arranged in the plasma torch shank into the space 26, and is balanced and set in rotation by the guide 27. The secondary gas SG1 then flows into the space 28 then exits the nozzle protection cap opening 250. It is also possible for one or more further bores 250a to be situated in the nozzle protection cap 25 or in a holder for the nozzle protection cap 25, through which further bores the secondary medium SG1 flows out.

The valve 63 is designed as an axial valve of small structural form. For example, it has an outer diameter D of 11 mm and a length L of 40 mm. It requires a low electrical power for operation, here for example approximately 2 W, in order to reduce the heating in the housing 30.

Upon ignition of the arc and during the cutting process, the plasma gas PG1 flows through the open valve 51 and the feeder 34 into the housing 30 and from there into the space 24 between the electrode 22 and the nozzle 21, and finally flows out through the nozzle bore 210 and the nozzle protection cap opening 250. After the cutting process, the valve 51 is closed again and the supply 34 of the plasma gas PG1 is evacuated.

The secondary medium, in this example a gas (secondary gas SG1), may be switched by the valve 63 at the same time as the valve 51 of the plasma gas PG1. Owing to the arrangement according to the invention of the valve 63 in the plasma torch shank 3 and close to the plasma torch head 2, the secondary medium SG1 may also be activated and deactivated at other points in time. During the plasma cutting process, firstly the pilot arc is ignited with a small electrical current, for example 10 A to 30 A, which pilot arc burns between the electrode 22 and the nozzle 21. When the plasma jet 6 generated by the pilot arc touches the workpiece W to be cut, the arc is transferred from the nozzle 21 to the workpiece W. The control of the plasma cutting system detects this by sensor means and increases the electrical current to the required value, depending on the workpiece thickness in the machining area to 30 A to 600 A.

During the time in which the pilot arc is burning, the secondary medium SG1 is not yet required. Said secondary medium even disrupts and shortens the plasma jet 6 emerging from the nozzle 21, because said secondary medium impinges laterally on said plasma jet. Therefore, the plasma torch 1 must be positioned with its nozzle protection cap opening 250 and/or openings 250a closer to the workpiece W. This in turn leads to the nozzle protection cap 25 and the nozzle 21 being put at risk by hot, upwardly spraying molten material. This is remedied by the secondary medium SG1 not being activated until the point in time at which at least a fraction of the electrical cutting current is flowing via the workpiece W and the arc has at least partially transferred to the workpiece W. Thus, on the one hand, the nozzle protection cap opening 250 of the plasma torch 1 can be positioned far enough away from the upper surface of the workpiece for the plunge cutting process, and the arc is nevertheless transferred. On the other hand, by means of an arrangement according to the invention, which ensures the fast feed and flow, with only little time delay, after the activation of the valve 63 of the secondary medium SG1, the nozzle protection cap 25 and the nozzle 21 are protected against upward-spraying molten hot material of the workpiece W to be machined. This is especially important in the case of thick workpieces to be cut with thicknesses greater than approx. 20 mm.

By contrast, in the case of relatively thin workpieces W, it is often even better if the secondary medium SG1 does not flow through the nozzle protection cap opening 250 until the workpiece W has been partially or completely pierced by the plasma jet 6. If the secondary gas does not flow during a part of the time of the hole piercing process or the entire time of the hole piercing process—which is the time required to completely pierce through the workpiece W—smaller plunge-cut holes can be realized. This results in fewer slag deposits on the workpiece surface that can disrupt the cutting process.

Even in the case of a start of cutting at an edge, it is expedient not to let the secondary medium SG1 flow and to keep the valve 63 closed, because here, too, the pilot arc transfers to the workpiece W already in the presence of a relatively great spacing, and more reliably starts a cutting process.

During the cutting process itself, the secondary medium SG1 is in turn required in order, by way of its influence, to improve the cut quality. This should occur immediately after the hole piercing or start of cutting in order to achieve a good cut quality from the beginning of the cutting process. The cut quality includes perpendicularity and angularity tolerance, roughness and burr attachment, as well as groove drag (DIN EN ISO 9013).

A non-flowing secondary medium SG1 can also have a positive effect upon the crossing of kerfs F or during the cutting of corners or roundings. The oscillation or pulsation of the plasma jet 6 can be reduced.

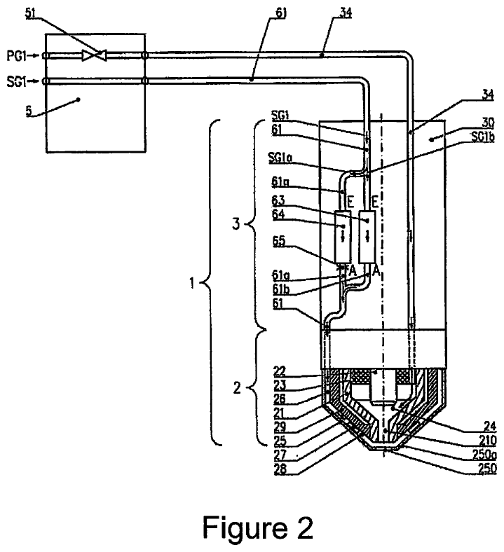

FIG. 2 shows an arrangement similar to that in FIG. 1, but two valves 63 and 64 connected in parallel are situated in the feeder 61 for the secondary medium SG1 in the housing 30 of the plasma torch 1. The feeder 61 of the secondary medium SG1 is thus divided into the feeders 61a with the valve 64 and 61b with the valve 63. It is thus possible to activate and deactivate the flow of the secondary medium SG1 at the points in time mentioned in the description relating to FIG. 1, but additionally also to rapidly change the volume flow in a simple manner. Here, by way of example, an aperture 65 is installed in the feeder 61a, which aperture reduces the volume flow in comparison to the feeder 61b, which can be achieved by means of the correspondingly smaller free cross section through which the secondary medium SG1 can flow. The feeders 61a and 61b of the partial gas streams of secondary medium SG1a and SG1b of the secondary gas SG1 are in this case merged again in the plasma torch shank 3. Thus, only one feeder 61 to the plasma torch head 2 for the secondary medium SG1 needs to be provided. This is advantageous in particular for a plasma torch 1 with quick-exchange head.

A reduction of the secondary medium flow has a positive effect at the same points in time as the portions without flowing secondary medium SG1 as described in the example according to FIG. 1.

Due to the additional possibility of setting volume flows of different magnitude in addition to the rapid activation and deactivation of the flow of the secondary medium SG1, the plasma cutting process can be further improved, in particular at the transitional processes such as plunge cutting, start of cutting, passing over a kerf F, cutting a corner or a rounding.

Furthermore, by contrast to the example according to FIG. 1, the nozzle 21 is in this case fixed by a nozzle cap 29. This allows a cooling medium, for example cooling water, to flow (not illustrated) in the space between the nozzle 21 and the nozzle cap 22.

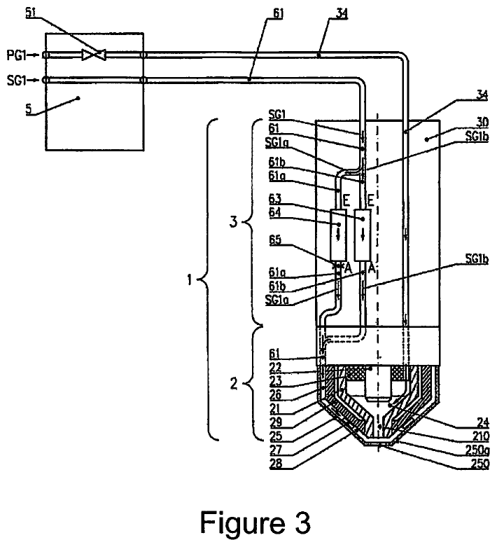

FIG. 3 shows, by way of example, an arrangement similar to FIG. 2, but the feeders 61a and 61b of the secondary media SG1a and SG1b are first merged to form the secondary medium SG1 in the plasma torch head 2. In this example, the merging takes place further upstream of the guide 27 of the secondary medium as viewed in the flow direction of the secondary medium SG1.

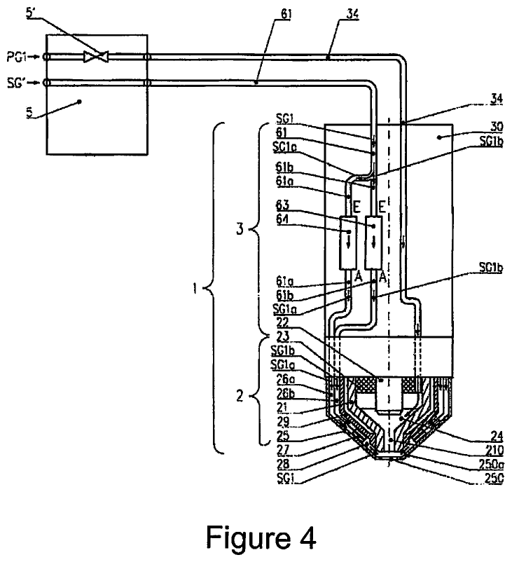

FIG. 4 likewise shows an arrangement in which the feeders 61a and 61b of the secondary medium SG1 are first merged in the plasma torch head 2. In this example, the merging takes place in the from the nozzle protection cap 25 and nozzle cap 29, downstream of the gas guide 27 of the secondary medium in the flow direction of the secondary medium SG1. The gas guide 27 has two groups of openings, one group for the secondary medium SG1a and the other group for the secondary medium SG1b.

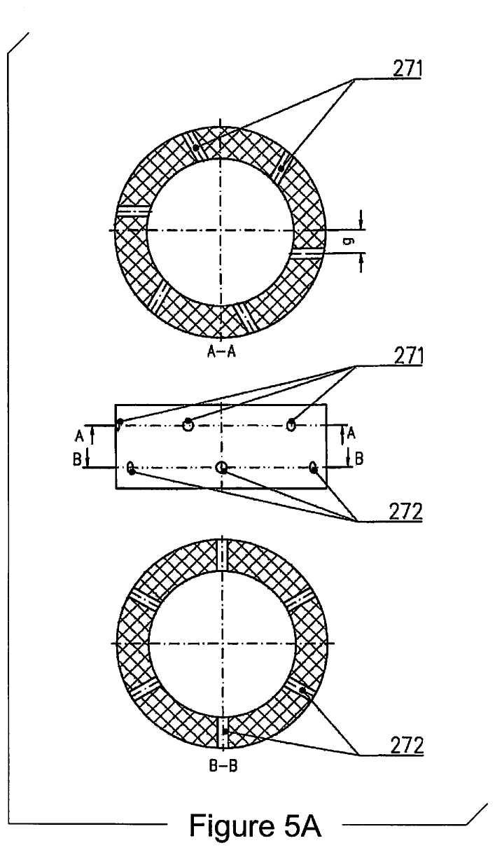

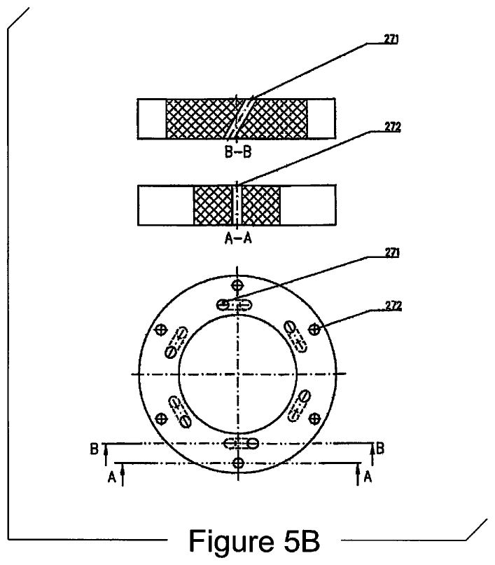

The openings advantageously differ in their design, dimensioning and/or orientation of their central axes (dash-dotted lines), in this case for example in terms of offset from the radial. The openings 271 and 272 of the groups may be arranged in different planes and in each case offset with respect to one another in the planes. This is also shown in FIGS. 5A and 5B. Thus, the secondary medium SG1 can be divided into two differently rotating secondary medium streams SG1a and SG1b as well as SG1 and SG2, which ultimately flow around the plasma jet 6.

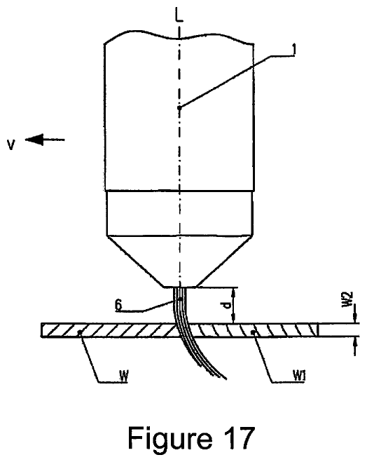

During the plunge cutting into the material of the workpiece W, it is often the case that little or no rotation of a flowing secondary medium SG1 is expedient, whereas a more intense rotation is advantageous during the cutting process. By means of a greater offset g from the radial, the rotation of the exiting secondary medium flow is increased. There is the additional resulting possibility of influencing the cut quality during the cutting process by switching or jointly activating the flows of the secondary media SG1a and SG1b. In this case, long straight portions are cut with intense rotation of the outflowing secondary medium SG1 and high advancing speed, and small portions are cut with less intense rotation of the outflowing secondary medium SG1 and lower advancing speed. A long portion usually begins at a length which corresponds to at least twice the thickness of the workpiece W to be cut, but is at least 10 mm in length. With more intense rotation, that is to say greater angular velocity of the flow of the secondary medium SG1, cutting can be performed faster, and with less intense rotation, cutting must be performed more slowly. However, a lower advancing speed is advantageous for cutting small portions, for example small radii which amount to for example less than twice the thickness of the workpiece W, sawteeth, tetragonal contours whose edge length is likewise less than twice the thickness of the workpiece W in the respective machining area. Owing to the relatively low advancing speed, the guide system guides the plasma torch 1 more accurately even in the event of directional changes in the movement performed. In addition, the plasma jet 6 does not drag, and the groove drag is reduced, which has a positive effect at corners on internal contours (FIG. 17) and internal corners. In the case of long portions, this is not of importance, and here cutting can be performed with intense rotation of the flow of the secondary medium SG1 and with a relatively high advancing speed.

FIGS. 5A and 5B show, by way of example, a guide 27 for the secondary medium, here by way of example gas, which is designated here as secondary gas SG1, SG2, SG1a and SG1b.

The group of bores 271 are for the secondary medium SG1 or SG1a, the bores of the group 272 for the secondary medium SG2 or SG1b. The bores of a group are arranged in one plane. The group of bores 271 has, by way of example, an offset with respect to the radial of 3 mm, and the group of bores 272 no offset with respect to the radial. If this guide 27 is installed in the plasma torch 1 of FIG. 4, the flow of the secondary medium SG1a which is fed through the feeder 61a and the group of bores 271 exhibits more intense rotation with a higher angular velocity than the flow of the secondary medium SG1b which is fed through the feeder 61b and the group of bores 272. Other openings, such as for example grooves, squares, semicircular or angular shapes, are also possible as bores 271 and 272. Likewise, the openings may have free cross sections of different size through which secondary medium can exit.

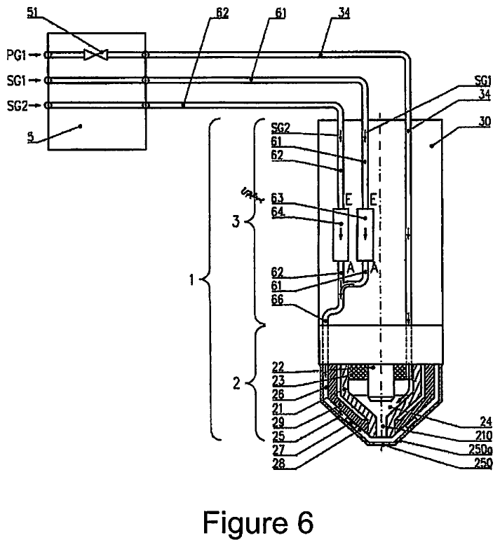

The arrangement according to FIG. 6 has the features of the example according to FIG. 1, but has, in addition to the feeder 61 for the secondary medium SG1, a feeder 62 for a second secondary medium SG2. The feeders 61, 62 may, outside the housing 30, be hoses 30 which are connected, for a feed of the secondary media SG1, SG2, to a coupling unit 5. The hoses are adjoined in each case by a further part of the feeders 61, 62 and in each case by the valve 63, 64, which are arranged within the housing 30.

The feeders 61 and 62 of the secondary media SG1 and SG2 are in this case merged again in the plasma torch shank 3. Thus, only one feeder 66 to the plasma torch head 2 needs to be provided for the secondary media SG1 and SG2. This is particularly advantageous for a plasma torch 1 with quick-exchange head.

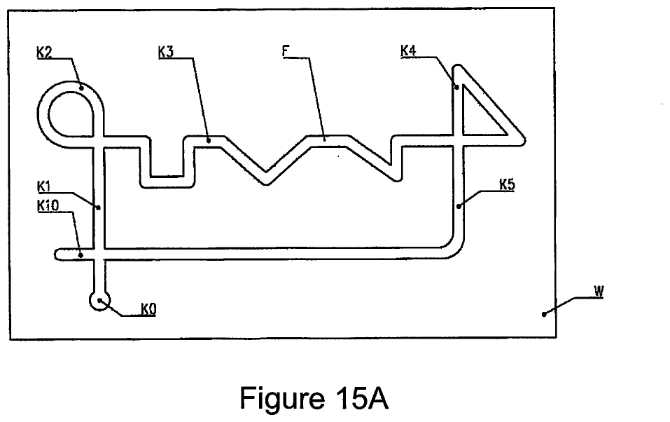

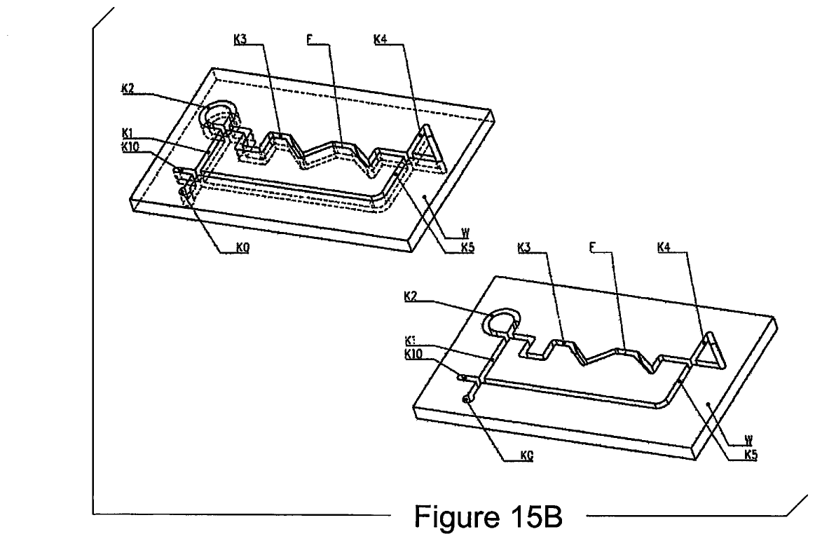

By this arrangement, in addition to the rapid activation and deactivation and the rapid change of the volume flow of the secondary media streams, the composition of the exiting secondary medium can also be performed by switching or simultaneous activation of the valves 63, 64. Thus, in a workpiece W composed of structural steel, small contours or small portions are cut with a secondary medium mixture which has a higher fraction of oxygen in relation to a fraction of nitrogen; CO₂, air or argon than in the case of large portions. The statements made in the explanation of FIG. 4 apply here. By way of example, such contours are also illustrated in FIGS. 15a and 15b. The oxygen fraction is then over 40 vol %. K3 is a small portion and the portions K1 and K5 are relatively large portions.

It is likewise advantageous if, during the plunge cutting into structural steel, plunge cutting is performed with oxygen as the sole secondary medium, because in this way, the melt is made more inviscid, and the plunge cutting takes place faster. During the cutting process itself, an excessively high oxygen fraction can again lead to the formation of irregularities on the cutting edge or surface. In this case, too, fast switching is advantageous.

Another application is the use of a liquid, for example water, as one of the secondary media used. It is thus advantageously possible, for the plunge cutting into structural steel, for water to flow as secondary medium SG1. This prevents or reduces the upwardly spraying hot metal sputter and thus protects the plasma torch 1 and also the surroundings. After the piercing through the workpiece W, the water is turned off and a gas or gas mixture flows as secondary medium SG2. The method may also be used for high-alloy steel and non-ferrous metals.

Furthermore, the secondary medium or secondary medium mixture may also be changed, with regard to the parameters such as flow velocity, volume flow, rotation and composition, upon the transition from perpendicular cutting to bevel cutting. In the case of bevel cutting, the plasma torch 1 (central axis) is not at right angles to the workpiece surface as in the case of perpendicular cutting, but rather is inclined to form a cut edge with a certain angle. This is advantageous for the further machining, generally a subsequent welding process. Since the effective thickness of the workpiece W to be cut changes (increases) upon the transition from perpendicular to bevel cutting, changed parameters are then expedient for a higher cut quality. The same applies in principle for the transition from bevel cutting to perpendicular cutting (reduction).

It is also advantageous if the change of the parameters takes place in portions which did not lie on the cut contour after cutting-out of the workpiece W, that is to say for example at the start of cutting, corners that have been traveled around, at the end of cutting, passing over a kerf or other parts of the “waste piece”.

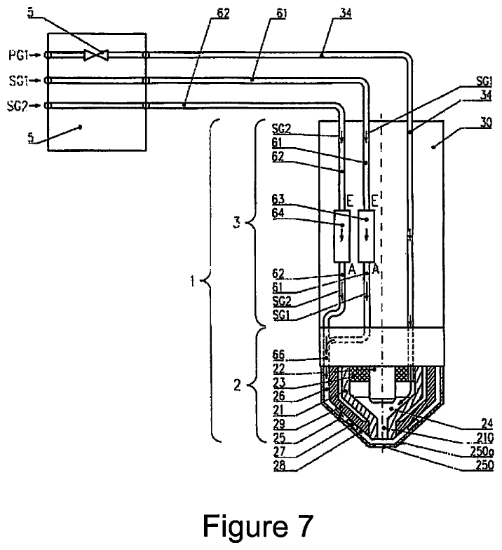

FIG. 7 shows, by way of example, a similar arrangement to FIG. 6, but the feeders 61 and 62 of the secondary media SG1 and SG2 are first brought together in the plasma torch head 2. In this example, the merging takes place upstream of the guide 27 for the secondary media as viewed in the flow direction of the secondary media SG1, SG2.

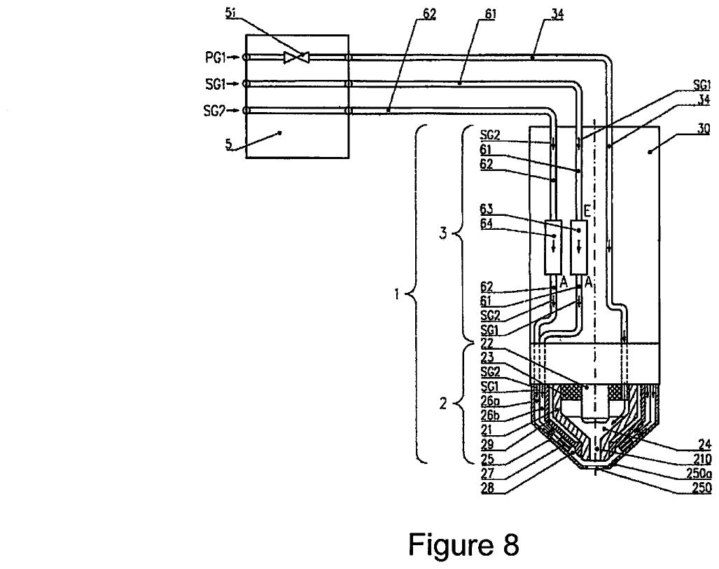

FIG. 8 likewise shows an arrangement in which the feeders 61 and 62 of the secondary media SG1, SG2 are first merged in the plasma torch head 2. FIG. 8 has all of the advantages of the example according to FIG. 6.

Further advantages will be described below. In this example, the merging of the secondary media SG1 and SG2 takes place upstream of the nozzle protection cap 25 and nozzle cap 29 in the flow direction of the secondary media SG1, SG2 and downstream of the guide 27 for the secondary media. The guide 27 has two groups of openings, one group for the secondary medium SG1 and the other group for the secondary medium SG2.

Advantageously, the openings 271 and 272 differ in terms of their design, in this case for example in terms of the offset from the radial. This is also shown in FIG. 5A. Thus, the secondary medium SG1 can form a differently rotating secondary medium flow than the secondary medium SG2, which ultimately flow around the plasma jet 6.

During the plunge cutting into the workplace material, it is often the case that little or no rotation of the secondary media SG1, SG2 is expedient, whereas a relatively intense rotation with a relatively high angular velocity is desired during the cutting process. By means of a greater offset from the radial, the rotation is increased. There is the additional resulting possibility of influencing the cut quality during a cutting process by switching or jointly activating the flows of the secondary media SG1 and SG2. In this case, long straight portions are cut with intense rotation and high speed, and small portions are cut with less intense rotation and lower speed. A long portion usually starts at a length that corresponds to at least twice the thickness of the workpiece W to be cut in the respective machining area, but is at least 10 mm in length. With more intense rotation of the flow of the secondary medium/media, cutting can be performed faster, and with less intense rotation, cutting must be performed more slowly. However, a lower advancing speed is advantageous for cutting small portions, for example small radii which amount to for example less than twice the thickness of the workpiece Win the respective machining area, for example sawtooth-like contours, tetragonal contours whose edge length is likewise less than twice the workpiece thickness in the respective machining area. Owing to the relatively low advancing speed, the guide system guides the plasma torch 1 more accurately even in the event of directional changes in the advancing movement performed. In addition, the plasma jet 6 does not drag, and the groove drag is reduced, which has a positive effect at corners on internal contours and internal corners. In the case of long portions, this is not of importance, and here cutting can be performed quickly with intense rotation of the flow of the secondary medium/media.

In the case of this arrangement, the exiting secondary medium or secondary medium mixture may be changed with regard to the parameters such as flow velocity, volume flow, rotation of the flow and composition.

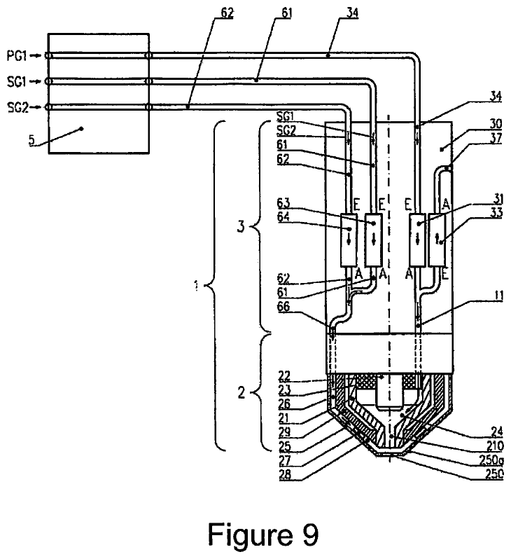

FIG. 9 additionally shows, in the feeder 34 of the plasma gas PG1, a valve 31 in the housing 30 of the plasma torch shank 3, which valve activates and deactivates the plasma gas PG1. The valve 33 serves for ventilating the cavity 11, which is necessary in particular at the end of cutting in order to ensure a rapid outflow of the plasma gas PG1.

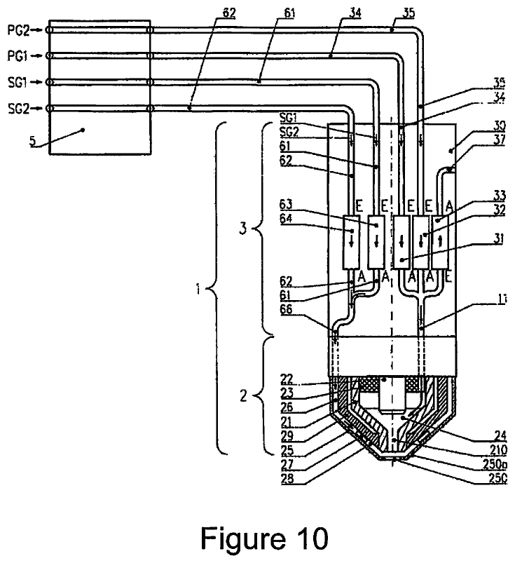

FIG. 10 shows, in addition to FIG. 9, the feeder 35 of a further plasma gas PG2, which is fed via a gas hose 35 and a valve 31 analogous to plasma gas PG1. In this way, by switching and activating the valves 31 and 32, a change of the plasma gases PG1 or PG2 can be performed in a manner dependent on the process state. The valve 33 likewise serves for ventilating the cavity 11.

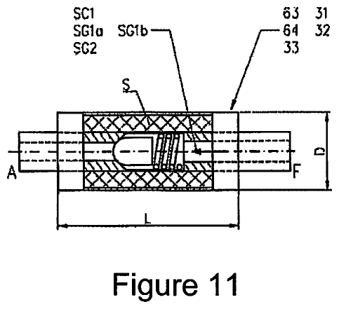

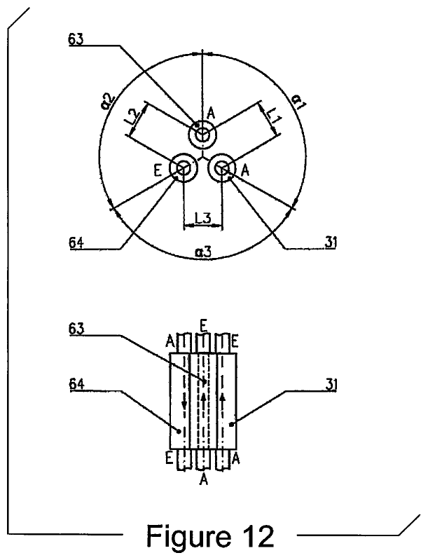

FIG. 11 shows the greatly simplified construction of an axial solenoid valve, such as may be used in the invention in the feeders for secondary media and plasma gas. Arranged in the interior of the body of said valve is the coil S with the windings, through which the plasma gas can flow from the inlet E to the outlet A. The mechanism for opening and closing is also arranged in the interior. The body of the solenoid valve has a length L and an outer diameter D.

The solenoid valve illustrated here has a length L of 25 mm and a diameter of 10 mm.

FIG. 12 shows a possible space-saving arrangement of the valves 31, 63 and 64. Said valves are arranged in the housing 30 so as to be arranged in a plane perpendicular to the central line M at an angle α1 of 120°. The deviation from this angle should not exceed ±30°. As a result, the arrangement is space-saving and can be arranged in the housing 30 or plasma torch shank 3. The spacings of the central longitudinal axes L1, L2 and L3 between the valves 31, 32, 33 are in each case ≤20 mm. Of the valves 31, 32 and 33, at least one valve is oriented with its inlet E oppositely with respect to the other valves, that is to say with respect to the outlets A thereof. The oppositely oriented valve is the valve 33 in the cavity 11 in the example shown.

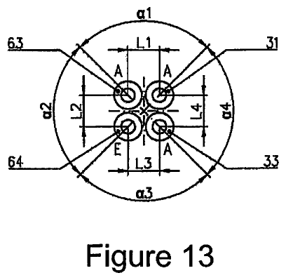

FIG. 13 shows an arrangement with four valves 31, 33, 63 and 64. Said valves are arranged in the interior of the housing 30 so as to be arranged in a plane perpendicular to the central line M at angles α1, α2, α3, α4 of 90°. The deviation from these angles should not exceed ±30°. As a result, the arrangement is space-saving and can be arranged in the housing 30 or plasma torch shank 3. The spacings of the central longitudinal axes L1, L2, L3 and L4 of the valves 31, 33, 63 and 64 are 20 mm. Of these valves 31 and 33, at least one valve is oriented with its inlet E oppositely with respect to the other valves, that is to say with respect to the outlets A thereof.

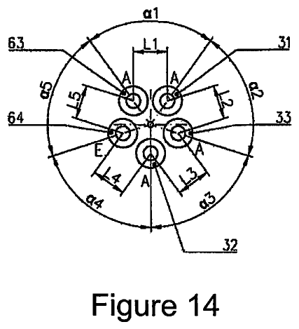

FIG. 14 shows an arrangement with four valves 31, 33, 63 and 64 as well as a further valve 32. Said valves are arranged in the interior of the housing 30 so as to be arranged in a plane perpendicular to the central line M at angles α1, α2, α3, α4, α5 of 72°. The deviation from these angles should not exceed ±15°. As a result, the arrangement is space-saving and can be arranged in the housing 30 or plasma torch shank 3. The spacings of the central longitudinal axes L1, L2, L3, L4 and L5 between the valves are 20 mm. Of these valves 31 to 33, at least one valve is oriented with its inlet E oppositely with respect to the other valves, that is to say with respect to the outlets A thereof.

FIG. 15A shows a schematic the contour guidance of a plasma torch for the purposes of cutting a contour out of a workpiece W in a view of the workpiece from above, and FIG. 15B shows the workpiece formed in a perspective illustration. It is the intention here to cut a workpiece with two long portions, contour K1, K5, and several short portions, contour K3. Portion K0 is in this case the start of cutting; plunge cutting into the workpiece is performed here. The portions contours K2 and K4 are necessitated by cutting technology in order to achieve a sharp corner and are situated in the so-called “waste part”; they are not part of the cut-out workpiece.

The following possibilities exist during the plunge cutting:
a. At the time of the pilot arc operation, the secondary medium is not yet required. Said secondary medium even disrupts and shortens the plasma jet 6 emerging from the nozzle 21, because said secondary medium impinges laterally on said plasma jet. Therefore, the plasma torch 1 must be positioned with its nozzle protection cap opening 250 with a relatively small spacing to the workpiece surface (FIG. 17, spacing d). This in turn leads to the nozzle protection cap 25 and the nozzle 21 being put at risk by hot, upwardly spraying molten material. This is remedied by the secondary medium not being activated until the point in time at which at least a fraction of the electrical cutting current is flowing via the workpiece and the arc has at least partially transferred to the workpiece. Thus, on the one hand, the nozzle protection cap opening 250 of the plasma torch 1 can be positioned with a relatively great spacing d to the workpiece surface for the plunge cutting process, and the arc is nevertheless transferred.
   As a result of a flow of the secondary medium SG1 with a relatively high flow velocity, the nozzle protection cap 25 and the nozzle 21 are protected from hot, upwardly spraying molten material of the workpiece to be machined. This is particularly important in the case of thick workpieces to be cut, of greater than approx. 20 mm in the respective machining area.
   For this purpose, use may for example be made of a plasma torch 1 corresponding to FIGS. 1 to 10.
b. In the case of relatively thin workpiece thicknesses, it is more expedient for secondary medium to first flow through the nozzle protection cap opening 250 when the workpiece has been partially or completely pierced. If the secondary medium does not flow during a part of the time of the hole piercing process or the entire time of the hole piercing process—which is the time required to completely pierce through the workpiece—smaller plunge-cut holes are realized. This results in fewer slag deposits on the workpiece surface that can disrupt the cutting process.
   Secondary medium should flow out of the nozzle protection cap opening 250 at the earliest at the point in time at which, during the plunge cutting into a workpiece, the workpiece has been pierced by at least ⅓, better by half, and ideally completely.
   For this purpose, use may for example be made of a plasma torch corresponding to FIGS. 1 to 10.
c. Furthermore, during the plunge cutting into the workpiece, it is often the case that little or no rotation of the secondary media SG1, SG1a, SG1b, SG2 is expedient, whereas a relatively intense rotation with a relatively high angular velocity is expedient during the cutting process. For this purpose, use may for example be made of a plasma torch 1 corresponding to FIGS. 4 and 8. As a result of a greater offset of the openings 271 and 272 from the radial in the gas guide 27 for the secondary media, the secondary media SG1a and SG1b (FIG. 4) and SG1 and SG2 (FIG. 8) rotate with different intensities.
   The change of the rotation of the secondary medium or of the secondary media should occur from the nozzle protection cap opening 250 at the earliest at the point in time at which, during the plunge cutting into a workpiece, the workpiece has been pierced by at least ⅓, better by half, and ideally completely.
d. Likewise, for the plunge cutting into structural steel, it may be advantageous if water flows as secondary medium SG1. This prevents or reduces the upwardly spraying hot metal sputter and thus protects the plasma torch 1 and also the surroundings. After the piercing through the workpiece, the water is turned off and a gas or gas mixture flows as secondary medium SG2.
   The change from water to gas as secondary medium should occur from the nozzle protection cap opening 250 at the earliest at the point in time at which, during the plunge cutting into a workpiece, the workpiece has been pierced by at least ⅓, better by half, and ideally completely.
   The method may also be used for high-alloy steel and non-ferrous metals.
   For this purpose, use may for example be made of a plasma torch 1 corresponding to FIGS. 6 and 10.
e. It is likewise advantageous if, during the plunge cutting into structural steel, plunge cutting is performed with oxygen or a relatively high oxygen fraction in a secondary medium mixture, because then, the melt is made more inviscid, and the plunge cutting takes place faster. During the cutting process itself, an excessively high oxygen fraction can again lead to the formation of irregularities on the cutting edge or surface. A change of the secondary medium between the plunge cutting and the cutting process may be advantageous also for the cutting of high-alloy steel, aluminum and other metals. The change of outflowing secondary medium should occur from the nozzle protection cap opening 250 at the earliest at the point in time at which, during the plunge cutting into a workpiece, the workpiece has been pierced by at least ⅓, better by half, and ideally completely.
   For this purpose, use may for example be made of a plasma torch 1 corresponding to FIGS. 6 and 10.
f. It may be particularly advantageous if, during the plunge cutting into the workpiece, the secondary medium and the rotation of the flow of the secondary medium are changed. The effects described under points c. and e. arise here. As plasma torch 1, use may for example be made of that shown in FIG. 8.

It may basically be advantageous for the secondary medium/media to be changed in terms of one or more parameters, such as for example flow velocity, volume flow, rotation of the flow and composition, during the phase of the plunge cutting in relation to other operating states.

After the piercing, the cutting movement is performed with the selected secondary medium. After the piercing of the workpiece contour K0, the long portion K1 is cut, following which it is sought to travel around the corner in the portion contour K2. A sharp-edged corner is obtained if the plasma cutting torch 1 is guided as in corner portion contour K2. Here, as is also illustrated in FIG. 15a, the plasma cutting torch 1 departs from the contour of the part to be cut and is guided over the “waste part” in order to then return again to the contour of the part to be cut. This is also referred to as “travelled-around corner”. The portion contour K2 is adjoined by a portion contour K3 with an exemplary sequence of small portions with advancing axis direction changes. During the time in which the plasma torch 1 is guided over the “waste part” in the portion contour K2, at least one changes took place on the outflowing secondary medium.

The following possibilities exist when traveling over the “waste part” on contour K2:
a. It is advantageous to influence the cut quality during the cutting process by changing the rotation of the flow of the secondary medium/media. Here, long straight portions are cut with intense rotation and high-speed and small portions are cut with less intense rotation and a lower advancing speed. A long portion usually starts at a length that corresponds to at least twice the workpiece thickness in the respective machining area of the workpiece to be cut, but is at least 10 mm in length. With more intense rotation of the flow of the secondary medium/media, cutting can be performed with a higher advancing speed, and with less intense rotation, cutting must be performed with a lower advancing speed. However, a lower advancing speed is advantageous for cutting small portions, for example small radii which are for example less than twice the workpiece thickness in the respective machining area, for example sawtooth-like contours, tetragonal contours whose edge length is likewise less than twice the workpiece thickness. Owing to the relatively low advancing speed, the guide system guides the plasma torch 1 more accurately even in the event of directional changes in the movement performed. In addition, the plasma jet 6 does not drag, and the groove drag is reduced, which has a positive effect at corners on internal contours and internal corners. In the case of long portions, this is not of importance, and here cutting can be performed with intense rotation of the flow of the secondary medium/media and with a relatively high advancing speed.
   For this purpose, use may for example be made of a plasma torch 1 corresponding to FIGS. 4 and 8.
b. It is furthermore advantageous during the cutting process to make a change to the volume flow and/or the composition of the secondary medium. Thus, in a workpiece composed of structural steel, small contours or small portions are cut with a secondary medium mixture which has a higher fraction of oxygen than in the case of large portions. The oxygen fraction is then over 40 vol %.
   For this purpose, use may for example be made of a plasma torch 1 corresponding to FIGS. 6 to 10.
c. It is particularly advantageous if the possibilities described in points a. and b. are combined.
   For this purpose, use may for example be made of a plasma torch according to FIG. 8.
d. In the case of this arrangement, the secondary medium or secondary medium mixture may be changed with regard to the parameters such as flow velocity, volume flow, rotation of the flow and composition.
e. In principle, it may be advantageous to change the secondary medium or secondary medium mixture in terms of one or more parameters such as for example flow velocity, volume flow, rotation of the flow and composition during the cutting process, and particularly advantageously when traveling over the “waste part”.

If the change in one of the described parameters occurs in the region of the waste part, that is to say not at a cut edge of the workpiece to be cut out, no transition or difference in cut quality is visible on the cut edge of this workpiece.

It is however also possible to perform a change of the parameters on a portion of the resulting cut edge of the workpiece. For this purpose, it is then however necessary to change not only the secondary medium but also at least one further parameter of the plasma cutting process, advancing speed, spacing plasma torch—workpiece surface (nozzle protection cap—workpiece surface), electrical cutting current and/or electrical cutting voltage. It is however also possible for one of the described changes of the secondary medium to be realized when traveling over a kerf F.

In the portion K10 end of cutting, the cutting process ends. Here, too, parameters of the outflowing secondary medium or secondary medium mixture may be changed once again.

After one of the described changes of at least one parameter of the secondary medium or of the secondary media, the contour K3 with the small portions is cut with the parameter(s) best suited thereto.

The change to the parameters on the portion with long contour K5 takes place in region K4 on the “waste part” analogously to the change in the portion contour K2.

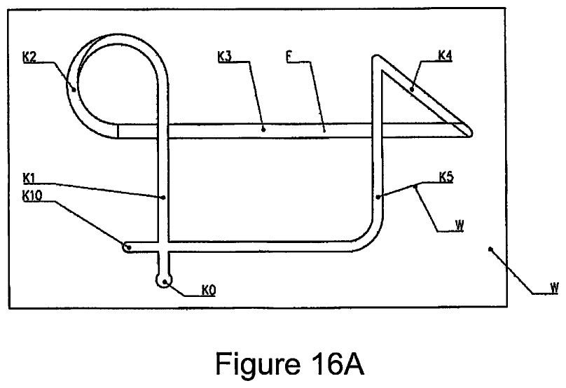

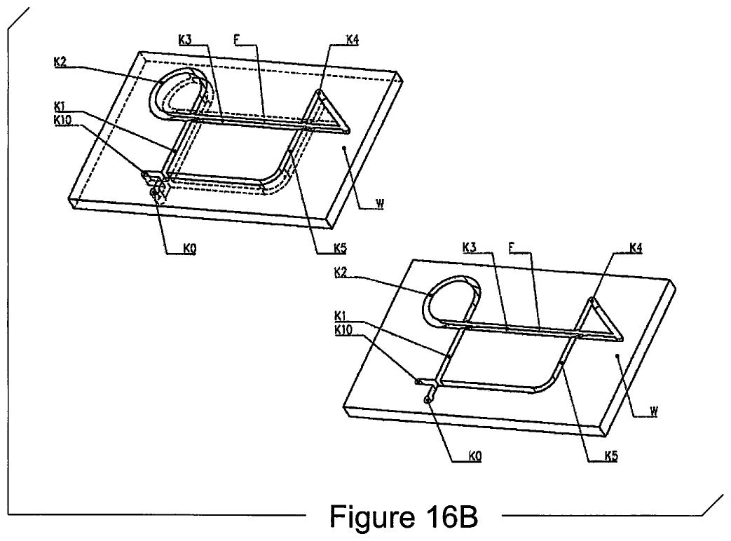

FIGS. 16A and 16B likewise show a cut component. In this case, too, a form of the change of the outflowing secondary medium as described in FIGS. 15a and 15b takes place in the portions K2 and K4 between the portions K1 and K3 and K5. The parameters of the outflowing secondary medium for the portion are changed in relation to the portion K21, because in portion K3, a bevel is cut at an angle, for example 45°. This is also described in the final paragraph relating to FIG. 6.

FIG. 17 shows, by way of example, a plasma torch 1 with its positioning relative to the workpiece with the spacing d between nozzle protection cap 25 and workpiece W.

### LIST OF REFERENCE NUMBERS

1 Plasma torch
2 Plasma torch head
3 Plasma torch shank
5 Coupling unit
6 Plasma jet (pilot or cutting arc)
11 Cavity
21 Nozzle
22 Electrode
23 Gas guide
24 Space (between electrode-nozzle)
25 Nozzle protection cap
26 Space (nozzle-nozzle protection cap)
27 Media guide SG1, SG2, SG1a, SG2a
28 Space (nozzle-nozzle protection cap), toward the nozzle tip
29 Nozzle cap
30 Housing
31 Valve PG1
32 Valve PG2
33 Valve ventilation
34 Feeder PG1
35 Feeder PG2
37 Line
51 Valve
61 Feeder SG1
61a Feeder SG
61b Feeder SG1b
62 Feeder SG2
63 Valve SG1, SGla
64 Valve SG2, SG1b
65 Aperture
66 Feeder
210 Nozzle bore
250 Nozzle protection cap opening
250a Further bore
271 Bores in media guide 27 for secondary medium SG1, SG1a
272 Bores in media guide 27 for secondary medium SG2, SG1b
A Outlet
D Diameter
D Spacing plasma torch-workpiece
E Inlet
F Kerf
g Offset
K Contour of the cut workpiece
K0 Start of cutting, plunge cutting
K1 Portion contour 1
K2 Portion between two portions
K3 Portion contour 3
K4 Portion between two portions
K5 Portion contour
K10 End of cutting
L Length
Central axis of the plasma torch
PG1 Plasma gas 1
PG2 Plasma gas 2
SG1 Secondary medium 1
SGla Secondary medium 1a
SG1b Secondary medium 1b
SG2 Secondary medium 2
S Coil
L1-L4 Spacings of the valves
V Cutting direction, advancing axis direction
W Workpiece
W1 Cut surface
W2 Workpiece thickness
α1-α4 Angle

1. A plasma torch, in particular plasma cutting torch, having a feeder for plasma gas, in which at least one secondary media is guided by at least one feeder through a housing of the plasma torch to a nozzle protection cap opening and/or to further openings that are provided in a nozzle protection cap, and, in the at least one feeder, at least one valve for opening and closing the feeder is provided directly within the housing of the plasma torch.

2. The plasma torch as claimed in claim 1, wherein the at least one feeder is divided into at least two parallel feeders through which secondary medium flows in the direction of the nozzle protection cap opening and/or the further openings, and at least two valves, which are each individually activatable, for opening and closing divided feeders are provided within the housing.

3. The plasma torch as claimed in claim 2, wherein in at least one of the divided feeders, there is provided an aperture, a throttle, or an element which varies a free cross section of a divided feeder in relation to a free cross section in relation to the other divided feeder.

4. The plasma torch as claimed in claim 1, wherein at least two feeders for two different secondary media are led through the housing of the plasma torch to the nozzle protection cap opening and/or are led to further openings that are provided in the nozzle protection cap and, in the at least two feeders for in each case one secondary medium within the housing, there is provided in each case the at least one valve for opening and closing a respective feeder.

5. The plasma torch as claimed in claim 1, wherein the merging of divided feeders for one secondary medium or the merging of feeders for different secondary media is arranged within the housing of the plasma torch, within a plasma head, in a space formed with the nozzle or nozzle cap and the nozzle protection cap, and the confluence of secondary media streams from the divided feeders preferably occurs before, during or after the passage through a gas guide of the plasma torch.

6. The plasma torch as claimed in claim 1, wherein at a gas guide, there are provided at least two openings or two groups of openings which guide the respective secondary medium; wherein openings have free cross sections of different size and geometrical shape and/or are oriented in different axial directions, or openings of different groups are arranged radially offset with respect to one another and/or the number of openings is chosen differently in the individual groups.

7. The plasma torch as claimed in claim 1, wherein at least one cavity which is connected to a feeder is provided within the housing, at which cavity, at an opening, there is provided a valve which opens and closes the opening so that a discharge of at least one plasma gas from the at least one feeder for the plasma gas to the nozzle protection cap opening can be realized when the valve is in an open state.

8. The plasma torch as claimed in claim 1, wherein valves arranged within the housing are electrically, pneumatically or hydraulically actuatable, and are designed as axial valves, and have a maximum outer diameter or a maximum average surface diagonal of at most 15 mm and a maximum length of 50 mm, and/or
the maximum outer diameter of the housing is 52 mm and/or the maximum outer diameter of the at least one valve is ¼ of the outer diameter or of a maximum average surface diagonal of the housing, and/or the at least one valve requires a maximum electrical power consumption of 10 W for operation; in the case of electrically operable valve(s), the respective at least one secondary medium or plasma gas flows through a winding of a coil.

9. The plasma torch as claimed in claim 1, wherein the plasma torch is designed as a quick-exchange torch with a plasma torch shank which is separable from a plasma torch head.

10. The plasma torch as claimed in claim 1, wherein in addition to the nozzle protection cap opening or a holder of the nozzle protection cap, there is provided at least one opening through which at least a fraction of one of the at least one secondary media flows, wherein, in the case of several openings being provided, in each case one of the at least one secondary medium exits through one or more selected opening(s) in the direction of a workpiece surface.

11. The plasma torch as claimed in claim 1, wherein gaseous and/or liquid secondary media is used.

12. The plasma torch as claimed in claim 1, wherein the plasma torch is connected to a controller which is designed such that the at least one valve which is/are arranged in a feeder for secondary medium is/are open when at least a part of the electrical cutting current flows through a workpiece, such that in this operating state, a secondary medium can flow out of the plasma torch in the direction of a workpiece surface, and, in a time period in which a pilot arc is formed, the at least one valve is/are held closed, and/or
the at least one valve which is/are arranged in the at least one feeder for a secondary medium are opened at the earliest point in time at which, during plunge cutting into a workpiece, the workpiece has been penetrated completely, and/or
the at least one valve which is arranged in a feeder for secondary medium is activated and deactivated during start of cutting, between two cutting portions, upon the crossing of a kerf or at the end of cutting.
